(19) United States
(12) Patent Application Publication
(10) Pub. No.: US 2024/0282981 A1
(43) Pub. Date: Aug. 22, 2024

(54) STRUCTURE-INTEGRATED ELECTROCHEMICAL CELL AND STRUCTURE-INTEGRATED STACK CONSTRUCTED THEREFROM

(71) Applicant: Fraunhofer-Gesellschaft zur Förderung der angewandten Forschung e.V., München (DE)

(72) Inventor: Jan GIRSCHIK, Freiburg (DE)

(73) Assignee: Fraunhofer-Gesellschaft zur Förderung der angewandten Forschung e.V., München (DE)

(21) Appl. No.: 18/571,347

(22) PCT Filed: Jun. 22, 2022
(86) PCT No.: PCT/DE2022/100460

§ 371 Date: Dec. 18, 2023

(30) Foreign Application Priority Data
Jun. 22, 2021 (DE) 102021116066.9

(51) Int. Cl. H01M 8/0247; H01M 4/86; H01M 8/00; H01M 8/04082; H01M 8/04186; H01M 8/18

(52) U.S. Cl. CPC H01M 8/0247; H01M 4/8605; H01M 8/002; H01M 8/04186; H01M 8/04201; H01M 8/188; H01M 2250/20

(57) ABSTRACT

An electrochemical cell, more particularly a redox flow battery, and to a stack having a cell assembly composed of two or more electrochemical cells of this type. The cell includes at least one cell frame and at least one electrode, wherein the cell frame peripherally surrounds a cell interior, and wherein the cell frame has at least one supply channel for supplying a fluid into the cell interior and at least one discharge channel for discharging the fluid from the cell interior, and optionally at least one semipermeable membrane and optionally at least one bipolar plate. The cell frame, the electrode, the optional semipermeable membrane and the optional bipolar plate are substantially connected in a form-fitting manner to each other, more particularly substantially connected in a form-fitting manner to each other in the region of the active cell area. A cell of this type is particularly suitable for applications in aviation, shipping and space travel.

### CROSS-REFERENCE TO RELATED APPLICATIONS

This application is a 371 National Phase of PCT/DE2022/100460, filed Jun. 22, 2022, which claims priority to German Patent Application No. 10 2021 116 066.9, filed Jun. 22, 2021, both of which are incorporated herein by reference as if fully set forth.

### TECHNICAL FIELD

The application relates to the installation space-efficient integration of electrochemical reactors, in particular flow reactors, such as flow batteries, fuel cells, electrolyzers or water treatment cells (in particular for capacitive deionization or for electrodialysis), into the support and shaping structures of mobile elements or of stationary elements of space travel, wherein the flow reactors can, in addition to their primary functions, such as energy storage, energy conversion, raw material production or filtration, also perform other functions, such as mechanical reinforcement of the structures, support of heat management and/or absorption of radiation. Especially suitable for this purpose are electrochemical reactors which are flexurally flexible and, at the same time, pressure-stable (i.e., in particular stable against externally acting compressive forces).

The pressure stability (this being understood according to the application to mean essentially mechanical pressure stability) of the reactors, in particular flow reactors, is achieved according to the application by uninterrupted form-fitting of the flow cells, even in the region of the electrochemically active cell surface, with simultaneous flexural flexibility through the use of flexurally flexible materials and/or flexurally flexible structures. For fluid guidance, use can therefore be made of, for example, dimensionally stable porous electrodes, such as rigid nonwoven or rigid felt or metal foam. Besides the high installation space efficiency, total system efficiency can also be increased through the multiple use of the flow reactors.

Known from the prior art are electrochemical flow reactors comprising at least one anode, at least one cathode and at least one electrolyte which allows charge exchange between anode and cathode. In the operational state, fluids which ensure supply and discharge of reactants flow through the flow reactors.

Electrochemical flow reactors are usually composed of multiple electrochemical flow cells, which often have a planar and unflexible form and are bipolarly connected to form a cell stack. These stacks are usually cuboid, bulky structures, and although they make the functionality of the flow reactors possible, they can only be used with little installation space efficiency in mobile and stationary objects.

A fundamental way of accommodating electrochemical reactors in objects in a particularly installation space-efficient manner would be to integrate the reactors in pre-existing structures, such as the outer and/or interior walls of vehicles or flying objects. However, the reactors known from the prior art cannot be adapted in shape to the existing structures and also cannot take on the functions of the replaced structure.

One approach currently pursued in the prior art is to expand the functionality of electrochemical non-flow cells by structural battery composite materials composed of carbon fibers in a structural solid-state electrolyte matrix, the chemistry of the non-flow cells being based on lithium iron phosphate. The disadvantages of this approach are not only the costly and inconvenient research and development of novel cell chemistries suitable for the hitherto used structural materials, but also the exclusive suitability for electrochemical non-flow cells.

### SUMMARY

It is an object of the present invention to overcome the disadvantages of the prior art and to specify an electrochemical cell which preferably realizes two or more or all of the following properties: installation space efficiency in mobile and stationary objects, integratability into existing structures, in particular structures or structural elements automatically arising from the functionality of the particular mobile or stationary object (e.g., into the cylindrical or cuboid shell of spaceflight objects), flexibility, in particular flexural flexibility (especially in order to be able to realize adaptability to curved planes of the structures), mechanical pressure stability (especially in order to ensure the primary functionality of the electrochemical cell in the particular operational environment) and in addition optionally also for realization of other functions, such as mechanical reinforcement of the structures, usability for as many cell chemistries as possible (especially in relation to the permissible viscosity of the fluids used) and chemical and electrochemical resistance of the components of the cell that are used, such as electrodes and membranes.

This object is achieved by the subject matter disclosed herein, with advantageous configurations described below and in the claims.

According to the disclosure, an electrochemical cell, in particular a redox flow battery, comprising at least one cell frame and at least one electrode is provided, wherein the cell frame perimetrically encloses a cell interior, wherein the cell frame comprises at least one supply channel for supplying a fluid, in particular an electrolyte, into the cell interior and at least one discharge channel for discharging the fluid from the cell interior, and optionally at least one semipermeable membrane and optionally at least one bipolar plate, wherein the cell frame, the electrode and the optionally present semipermeable membrane and the optionally present bipolar plate are substantially connected in a form-fitting manner to one another. The stated components of the electrochemical cell are connected in a form fitting manner to one another especially during integration or for integration into a support and/or shaping structure of mobile or stationary elements, in particular orthogonally to the membrane plane in the region of the active cell surface or active cell surfaces. The form-fitting, in particular in the region of the active cell surface, can also be realized only through installation into the support and/or shaping structure. Form-fitting is especially also understood to mean a flush arrangement of the various components, the components no longer having positional flexibility in relation to one another. According to the application, form-fitting especially also achieves mechanical pressure stability. Besides the form-fitting, frictional fastening, for example by means of a screw connection, or integral fastening, for example by means of an adhesive, can be provided nevertheless.

According to the application, mobile elements are especially understood to mean vehicles (i.e., land vehicles and transportation, aircraft and spacecraft, and watercraft, for example spaceflight objects, ships or airplanes), and stationary elements of space travel are understood to mean, for example, space stations (for instance, future space stations on the moon).

A support and/or shaping structure is understood to mean a structural element of the mobile or stationary structure in which the electrochemical cell is disposed, i.e., in particular a structural element of the vehicle or of the stationary element of space travel. For example, the shaping structure can be the outer shell or the fuselage of the vehicle, but it can also be a cell, for example in the case of vehicles, in particular spaceflight objects or space stations, constructed from multiple modules or cells, or also be a fuselage section, especially in the case of aircraft. The shaping structure is usually a structural element which delimits or envelops a cell used by persons or which is composed of a plurality of such cells (such as an airplane fuselage). Examples include passenger cells, control stations or modules of a space station. The support structure can be, for example, transversely, diagonally or longitudinally reinforced support constructions which support an outer shell. The support and shaping structure can, however, also be a lining element within a vehicle fuselage or a vehicle cell, within which support structures are disposed.

An electrochemical cell according to the application is understood to mean all electrochemical cells know in the prior art. They are known in different configurations and are sometimes also referred to as electrochemical reactors, since electrochemical reactions take place in the electrochemical cells. Depending on their use, the electrochemical cells can be designed, for example, as galvanic cells in the form of electrochemical power sources that provide usable electrical energy as a result of chemical reactions at the various electrodes. Alternatively, the electrochemical cells can, however, also be electrolytic cells which serve for the production of certain products by application of an external voltage. Conceivable, for example, is the generation of hydrogen for fuel cells or the generation of oxygen by electrolysis of water. Accumulator cells serve, in alternation, as a power source like galvanic cells and moreover as a power store, as in the case of an electrolytic cell. Lastly, mention may also be made of water treatment via electrodialysis or capacitive deionization.

According to one embodiment, the cell is flexible, in particular flexurally flexible. The flexural flexibility can be substantially achieved by the use of flexurally flexible materials and/or flexurally flexible structures.

For example, flexurally flexible structures can be realized by specifically providing material recesses (conceivable for example are grooves, notches or nicks or generally V-shaped recesses) in the cell, especially also in the electrode, in a main surface or both main surfaces, said material recesses allowing adaptation to geometries of the structure, in particular support structure, into which installation is carried out. The recesses can be designed in such a way that essentially only a slit remains after installation. In other words, the geometry of the recess can be specifically provided (e.g., by choosing the opening angle of the V-shaped structure) such that, during installation, it automatically produces the internal geometry of the structure into which installation is carried out. This is advantageous especially in the area of space travel, since this requires maximum flexibility with respect to the specific installation position.

Certain materials allow per se a certain flexural flexibility (in this case, the materials are thus flexurally flexible materials), but exhibit mechanical pressure stability at the same time. Examples here include conductive porous polymers, conductive polymer-based composite materials or rigid nonwovens and felts and metal foams such as aluminum foam, nickel foam or titanium foam.

According to one embodiment, the cell can be designed in such a way that the surfaces enclosed by the cell frame are disposed with a clearance of on average 0.2 to 100 mm, in many cases 2 to 10 mm, from one another. Typically, however, the distance will be oriented to the structure into which installation is carried out; conceivable for example in the case of moon stations or the like is a comparatively large clearance which can be even over 100 mm. In the case of comparatively stiff electrode materials, rather thinner cells can be provided for sufficient bending strength, and in the case of cells comprising highly flexurally flexible materials or structures and very large surface areas in the porous electrodes (e.g., in the case of metal foams or in the case of conductive porous polymer composites having porosities of preferably more than 90%), very thick geometries may also be realized.

The present invention can be used in all types of electrochemical cells. However, particular preference is given to the invention in conjunction with accumulator cells and preferably, here, in conjunction with redox flow batteries, which themselves have already been known for a long time and in different designs. Such designs are, by way of example, described in EP 0 051 766 A1 and US 2004/0170893 A1. Hereinafter, the invention will be frequently elucidated with reference to redox flow batteries. Except in the case of embodiments exclusively restricted to redox flow batteries, the disclosure content is, however, also to be understood generally in relation to electrochemical cells.

An important advantage of redox flow batteries lies in the flexible scalability of performance and capacity and thus in their suitability of being able to store very large amounts of energy, even in the case of a low selected efficiency, and vice versa. The energy is stored in electrolytes, which can be kept ready in external tanks. The electrolytes usually comprise metallic ions of different oxidation states. To remove electrical energy from the electrolytes or to recharge same, the electrolytes are pumped through a so-called electrochemical cell. Besides the individual scalability of performance and capacity, the spatial separation of energy conversion and energy storage entails further advantages, such as a particularly low self-discharge and a theoretically nonexistent degradation of the electrodes. In the case of space travel, there is the possibility of bringing the electrolyte tanks to the operation sites in separate transports and only coupling them on-site to the redox flow battery cells integrated into the modules or stations, which allows larger dimensioning of performance and capacity with fixed transport capacities. The electrolyte containers can be disposed as a storage installation space outside of the cell installation space, for example outside of the spaceflight objects, but they can also be disposed in the same support and shaping structures as the electrochemical cells. In particular, structural integration of both the energy converter cells and the energy storage tanks is possible, such that they, for example in two or more layers, form part of the outer shell or the fuselage of the vehicle, for example the spaceflight object. The energy storage tanks can be filled with the storage media either before transport to the operation site or after arrival at the operation site, by an additional supply mission.

The electrochemical cell according to the application is generally formed from two half cells which are separated from one another by a separator in the form of a semipermeable membrane and which each comprise an electrolyte and an electrode. The function of the semipermeable membrane is to spatially and electrically separate the cathode and the anode of an electrochemical cell from one another. The semipermeable membrane must therefore be permeable to ions which bring about the conversion of the stored chemical energy into electrical energy or vice versa. Semipermeable membranes can, for example, be formed from microporous plastics and nonwovens made of glass fiber or polyethylene and so-called diaphragms. Redox reactions take place at both electrodes of the electrochemical cell, with electrons being released from the electrolytes at one electrode and electrons being taken up at the other electrode. The metallic and/or nonmetallic ions of the electrolytes form redox pairs and consequently generate a redox potential. Possible redox pairs are, for example, iron-chromium, polysulfide-bromide or vanadium. These redox pairs or else other redox pairs can in principle be in aqueous solution or nonaqueous solution.

The electrodes of a cell, between which a potential difference is formed owing to the redox potentials, are outside of the cell, for example electrically connected to one another via an electrical load. While the electrons outside of the cell move from one half cell to the other, ions of the electrolytes directly pass through the semipermeable membrane from one half cell to the other half cell. To recharge a redox flow battery, a potential difference can be applied, for example by means of a charger, to the electrodes of the half cells instead of the electrical load, and it is through this potential difference that redox reactions taking place at the electrodes of the half cells are reversed.

The described cell is formed by using, inter alia, cell frames which enclose a cell interior. Typically, the cell frames do not completely enclose the cell interior, but merely along a peripheral narrow side. Therefore, the cell frame runs around the edge of the cell interior perimetrically and separates two opposite sides of relatively large surface area from one another, and the sides for their part are in turn assigned to a semipermeable membrane or an electrode. Typically, the thickness of the cell frame, which is formed by the edge of the cell frame, is distinctly smaller than the width and the height of the cell frame, which define the opposite sides of relatively large surface area.

Each half cell of the electrochemical cell comprises such a cell frame, which are produced, for example, from a thermoplastic in an injection-molding process. Arranged between two cell frames is a semipermeable membrane which separates electrolytes of the half cells from one another in relation to convective material exchange, but allows diffusion of certain ions from one half cell into the other half cell. Moreover, the cell interiors are each assigned an electrode in such a way that said electrodes are in contact with the electrolytes flowing through the cell interiors. The electrodes can, for example, seal off the cell interior of each cell frame on the side facing away from the semipermeable membrane. According to the prior art, the cell interior can remain substantially free and only be filled by one electrolyte in each case; alternatively, the respective electrode can also be at least partially provided in the cell interior. In this case, the electrode is typically designed in such a way that the electrolyte can partially flow through the electrode. In particular, possible here are electrodes having a high specific surface area at which the corresponding electrochemical reactions can take place appropriately rapidly and/or extensively. This ultimately leads to a high volume-specific performance of the cell. However, according to the prior art, the cell interiors are also then, if the electrodes protrude into the cell interior, usually closed by the electrode on the side facing the semipermeable membrane. Possible as a nonporous part of the electrodes are also so-called bipolar plates, which can be coated, for example, with a catalyst or some other material.

Each cell frame comprises openings and channels through which the corresponding electrolyte can flow from a supply line into the respective cell interior, where they can be withdrawn again and supplied to a disposal line. The electrolytes of the half cells are transferred via the supply line and the disposal line from a reservoir container to a collection container. This allows reuse of the electrolytes, which consequently do not have to be either discarded or replaced.

If a redox flow battery comprises only a single cell, then present outside of the cell frames forming the half cells are supply lines for each half cell and disposal lines for each half cell. Each cell frame comprises at least two openings, at least one of which is connected to a supply line, while the at least one other opening is connected to the disposal line. Within the cell frame, each opening is connected to a flow channel which is open toward the cell interior. This allows the supply of electrolyte from the supply line to the cell interior via a supply channel and the discharge of the electrolyte which has flowed through the cell interior via a discharge channel. In order to distribute the electrolytes more uniformly across the breadth of the cell interior and to withdraw the electrolyte more uniformly across the breadth of the cell interior, the respective supply channel and/or discharge channel can be branched once or multiple times between the outer opening and the cell interior, i.e., in the region of the frame shell of the cell frame. Alternatively, a number of separate supply channels and/or discharge channels for supplying and for discharging electrolyte can be provided in the cell frame. In both cases, the electrolyte enters the cell interior via the outlet openings of the supply channels of one side of the cell frame with as uniform a distribution as possible and exits again from the cell interior via the discharge channels of the other side of the cell frame with as uniform a distribution as possible. What is thus attempted is to achieve flow through the cell interior that is as uniform as possible. The supply channels are connected at their other end to the supply line via inlet openings. Thus, the electrolyte can get from the supply line into the corresponding cell interior through the at least one supply channel of the cell frame of each half cell.

If necessary, a plurality of electrochemical cells of the same kind is combined in one redox flow battery. Usually, the cells are stacked one on top of the other to this end, and so the cells as a whole are also referred to as a cell stack. The electrolytes usually flow through the individual cells parallel to one another, whereas the cells are usually electrically connected in series. The cells are thus usually hydraulically connected in parallel and electrically connected in series. In this case, the charge state of the electrolytes in each one of the half cells of the cell stack is the same. To distribute the electrolytes onto the corresponding half cells of the cell stack and to jointly discharge the electrolytes from the respective half cells, half cells are interconnected with supply and disposal lines. Since a different electrolyte flows through each half cell or each cell interior of a cell, the two electrolytes must be separated from one another during passage through the cell stack. Therefore, what are generally provided along the cell stack are two separate supply lines and two separate disposal lines. Each of these channels is generally partially formed by the cell frames themselves, which have four openings to this end. The openings extend along the cell stack and form the supply and discharge lines with an arrangement in series and if necessary with separation from one another via sealing materials. In many cases, what is chosen with such cell stacks is an embodiment with flexurally flexible electrode materials, but also conceivable is an embodiment with flexurally flexible structures or mixed forms of the two.

In the case of a multiplicity of electrochemical cells, it has been found that, to increase power density, it is convenient if the electrodes at least partially engage in the cell interior at least in one of the half cells and are porous and the corresponding electrolyte flows through said electrodes.

The electrochemical cell according to the application comprises in the cell interior an at least partially porous electrode for the electrolyte to flow through from the at least one supply channel to the at least one discharge channel. Since the electrolyte can flow through the porous section of the electrode, but cannot flow through a likewise possible nonporous section of the electrode, the space occupied by the porous section of the electrode is classified as belonging to the cell interior, which is especially plausible from a functional point of view. The porous section of the electrode can be formed in one piece or multiple pieces, though a one-part configuration may be useful for the sake of simplicity.

According to one embodiment, the porous electrode can, according to the application, consist of a conductive porous polymer, a conductive polymer-based composite material (e.g., a composite of a relatively large proportion of polypropylene or polyethylene and a relatively small proportion of graphite and carbon black), a nonwoven-type or felt-type material, such as graphite nonwoven, and/or a metal foam or comprise one or more of these materials. A metal foam structure is understood here to mean, following the general definition of foam, a composite of two-phase systems that is formed from gaseous regions separated by solid metal walls (solid foam). Depending on the manufacturing process, the structures of the porous metals can differ greatly in appearance. The term metal foam is also used in the prior art as a synonym for porous metals having very different properties. A common characteristic feature is the high porosity of the structures of usually more than 90% and their specific production. Therefore, according to the application, metal foams also include metal meshes, nonwoven-type or felt-type structures and generally open-porous structures based on fibers or wovens (such as woven fabrics and knitted fabrics).

The metal foam according to the application can consist of a metal (including an alloy), but an alternative possibility is a metal structure having a coated surface (for instance, in order to ensure improved chemical stability against the fluid or the electrolyte), in particular the complete surface of the metal foam facing the fluid. It is also possible—if realizable by the production process—to use a base structure (e.g., polymer-based) coated with metal, as is possible with metallized textiles for example.

According to the application, metal foams having at least partially open-porous structures are necessary in order to ensure transfer of the electrolytes. The pores of an open-porous region are interconnected. The production of metal foams is known from the literature and can be carried out, for example, by:
foaming of melts with the aid of blowing agents,
foaming of melts by means of gas injection or by means of dissolved gases,
precision casting starting from a polymer model of the later metal foam,
melt infiltration into placeholder structures,
sintering of bulk powder and bulk granular material, as used for example for production of open-porous structures for filter applications,
sintering or soldering of individual fibers and wires made of metal to form porous structures or further processing of metal textiles or metallized textiles to form porous structures,
additive manufacturing (which especially allows high resource efficiency and a topology optimized for the intended application),
slip reaction foam sintering process.

The porosity of the electrode provides a distinctly larger interface between the electrode and the electrolyte, which promotes the processes and reactions taking place in the corresponding interface. The processes and reactions take place especially more rapidly and/or more extensively.

In this connection, it is particularly convenient if the electrode comprises different sections. A porous section of the electrode is provided in the cell interior and electrically conductively connected to a nonporous section of the electrode. An electrolyte cannot pass through the nonporous section of the electrode, but can pass through the porous section of the electrode. This can be utilized for at least partially closing the cell interior. The cell interior is suitably closed especially on one side of the cell frame that is opposite a semipermeable membrane and for its part can close the cell interior on the corresponding side. The cell interior is closed by the electrode and the semipermeable membrane on the sides defining the length and width of the cell frame and by the cell frame itself on the narrow sides of the cell frame defining the height or thickness of the cell frame. However, this does not exclude supplying electrolyte to the cell interior via the at least one supply channel and/or withdrawing electrolyte via the at least one discharge channel. In this way, a cell stack composed of multiple electrochemical cells stacked one on top of the other can also be formed very simply and efficiently. Irrespective of this, the nonporous section of the electrode can be in the form of a bipolar plate. Bipolar plates have already been used in combination with porous electrodes in a number of known electrochemical cells. For the sake of simplicity, a similar configuration also appears advantageous here. In principle, the cell structure according to the invention which is form-fitting and frequently also flexurally flexible is also realizable if the electrode is not porous, for example if nonporous electrodes with integrated fluid guidance are used.

If the porous region of an electrode of an electrochemical cell or a cell stack has a long length through which to flow, this results in elevated pressure losses. However, correspondingly elevated internal cell pressures of in some cases more than 1.5 bar are always undesirable because this can easily lead to leaks and irreversible damage to the electrochemical cell or the cell stack.

The pressure loss of the electrolyte across the cell interior can be reduced by making the flow of the electrolyte through the cell interior more uniform. In order to achieve this, at least one preferably rectangular flow channel can be set in the electrode. The flow channel is distinguished by the fact that the free flow cross-section in the flow channel is distinctly larger, in particular many times over, than the average pore diameter of the porous section of the electrode. Electrolyte can then get into the pores of the electrode via the flow channel. Alternatively or additionally, electrolyte escaping from the pores of the electrode can be collected in the flow channel. Against this background, it is also particularly useful if the at least one flow channel is set in the porous section of the electrode. Alternatively or additionally, it is accordingly also convenient if the at least one flow channel follows an inlet opening and/or outlet opening. In this case, the electrolyte to be distributed can be distributed in the porosity of the electrode via the flow channel and/or the electrolyte to be collected can be collected via the flow channel.

Furthermore, a uniform and predictable flow can be ensured if at least one flow channel of the electrode that follows an inlet opening and at least one flow channel of the electrode that follows an outlet opening are spaced from each other by means of a porous section of the electrode for electrolyte to flow through. In this case, a so-called bypass flow cannot occur; instead, the electrolyte must always flow a minimum distance through the pores of the porous section of the electrode. In the case of a plurality of such flow channels, it is for this reason further useful if they are each spaced from each other by means of a porous section of the electrode for electrolyte to flow through.

The flow of the electrolyte can be distributed uniformly onto the cell interior of the cell frame if the flow channels following at least one outlet opening and the flow channels following at least one outlet opening alternate with each other in at least one direction. This direction is preferably oriented parallel to a plane defined by the cell frame.

According to the application, the use of electrochemical flow reactors which are flexurally flexible and, at the same time, mechanically pressure-stable means that they can be directly integrated into support and shaping structures of mobile and stationary elements, which can lead to higher installation space efficiency and, as a result of the multiple use of the flow reactors, to higher total system efficiency. Moreover, since this only requires adapting the construction of the electrochemical flow cells and especially the electrode material, there is no need for the costly and inconvenient research and development of novel cell chemistries and it is also possible to use cell chemistries that are already known, especially those having particularly high energy and/or power densities.

The mechanical pressure stability of the flow reactors is achieved by uninterrupted form-fitting of the flow cells, even in the region of the electrochemically active cell surface, with simultaneous flexural flexibility through the use of flexurally flexible materials and/or structures. The cells have a substantially form-fitting design, substantially form-fitting being understood to mean that a certain positional flexibility of the cell components may (but need not always) be necessary for installation of the cell into a certain structure, but complete form-fitting of the battery cell components is realized in the installed state. Positional flexibility is to be understood to mean that, in the still uninstalled state, a membrane, bipolar plate or else an electrode (e.g., when using a metal mesh) can still be in an untensioned state. As a result of installation, the tension is typically produced. In contrast to an uninstalled cell, the installed cell therefore usually no longer has positional flexibility, but is generally still flexurally flexible up to a certain degree. For fluid guidance, use can therefore especially be made of particularly dimensionally stable porous electrodes, such as metal foam, in particular meshes, and also nonwoven-type or felt-type structures. In many cases, flexural flexibility, however, will be significantly lower in the installed state than in the uninstalled state, and there will often be essentially no flexural flexibility. A certain flexural flexibility is only required so that mechanical stresses (as occur for example when launching a rocket or an airplane) acting on the support or shaping structure into which the cell is installed can be tolerated. Therefore, according to the application, “essentially no flexural flexibility” means that the flexural flexibility can disappear upon installation to the extent that only the mechanical stress on the mobile or stationary element (or of the substructures thereof) has to be taken account of and said mechanical stresses can be absorbed by the residual flexural flexibility.

To further improve mechanical stability, stabilization structures can be disposed in the cell, said stabilization structures allowing force absorption in the direction of the compressive forces acting on the cell. In particular, mention may be made here of stabilization structures in the manner of a honeycomb in which the individual honeycomb elements are perforated in order to allow the fluid to flow through, or else column-type stabilization structures disposed between the semipermeable membrane and the bipolar plate. A structure in the manner of a honeycomb can be the honeycomb itself but can also be a diamond or a square or—in the case of more greatly curved and nonplanar geometries—for example subsurfaces of an Archimedean or Platonic solid. For such stabilization structures, recesses can be specifically provided in the geometries of the electrodes used, so that said stabilization structures are integrated into the electrode or electrode layer. In extreme cases, this embodiment can use as an alternative an electrode material which (despite flexural flexibility) dos not bring about mechanical stabilization of the entire structure of the electrochemical cell, for example a soft nonwoven. Thus, all known electrode materials, in particular porous ones, are possible in this embodiment.

The electrochemical flow reactors which are thus flexurally flexible and, at the same time, mechanically pressure stable can be integrated into support and shaping structures of mobile and stationary elements and can, in addition to their primary functions, such as energy storage, energy conversion, raw material production or filtration, also perform other functions, such as mechanical reinforcement of the structures, support of heat management or absorption of radiation.

One exemplary embodiment is the integration of flexurally flexible and pressure-stable redox flow battery cells into the support structure of the modules of a space station. The electrochemical flow cells can be disposed segmentally or circumferentially on the cylindrical structure.

Owing to the purely catalytic effect of the functional components of redox flow batteries, they have an enormous cycle stability and service life and should therefore be operational, for example, over the entire operational life of space station modules equipped therewith. Cost-intensive, time-consuming and resource-intensive missions to replace batteries would be unnecessary as a result. Owing to the integration of the redox flow battery cells into the support and shaping structure of the modules, it is possible, firstly, to save space and weight and, secondly, the redox flow cells can mechanically reinforce the support structure as a result of the pressure stability and can support heat management through the circulating liquid electrolytes and possibly even absorb cosmic radiation.

Besides redox flow batteries, water treatment reactors and reactors for electrochemical generation of oxygen could—as already mentioned—also be usefully integrated into the support structure of the space station modules.

### BRIEF DESCRIPTION OF THE DRAWINGS

FIG. 1 shows a view of a prior art electrochemical flow reactor;

FIG. 2 shows an electrochemical flow reactor according to the prior art composed of multiple electrochemical flow cells;

FIG. 3 shows in the bottom half of the picture, a bipolar sandwich structure of an electrochemical flow reactor, and in the top half shows a space station module with the bipolar sandwich structure in the outer shell;

FIGS. 4A-D show views of a cylindrical shaping structure in which an electrochemical flow reactor is integrated;

FIGS. 5A and 5B show a further embodiment of a cylindrical shaping structure;

FIG. 6 shows an electrode having a flexurally flexible structure;

FIGS. 7A-C show electrochemical flow cells having additional stabilization structures.

### DETAILED DESCRIPTION

The subject matter of the application will be more particularly elucidated below with reference to figures without restriction of generality:

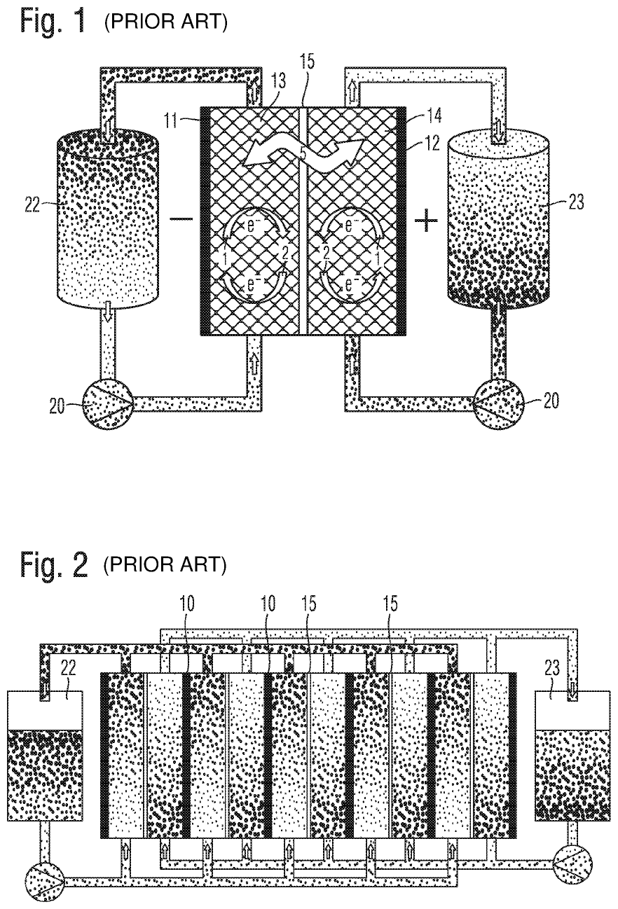

FIG. 1 shows an electrochemical flow reactor according to the prior art comprising two half cells, each of which contains an end electrode (11, 12) and a half cell space with graphite nonwoven electrode (13, 14). Each half cell space is filled with a fluid, and the fluid can be circulated by means of a pump (20) in each case. The fluid comprises an electrolyte having a redox-active species; FIG. 1 therefore shows an electrolyte tank containing an electrolyte having a redox-active species A (22) and an electrolyte tank containing an electrolyte having a redox-active species B (23). The electrolyte allows charge exchange between anode and cathode, with ions being able to diffuse through a membrane (5) both during the charge process (1) and during the discharge process (2).

FIG. 2 shows an electrochemical flow reactor according to the prior art composed of multiple electrochemical flow cells connected to form a cell stack. The individual flow cells are connected to one another via bipolar plates (10); disposed between the half cells are membranes (15) in each case.

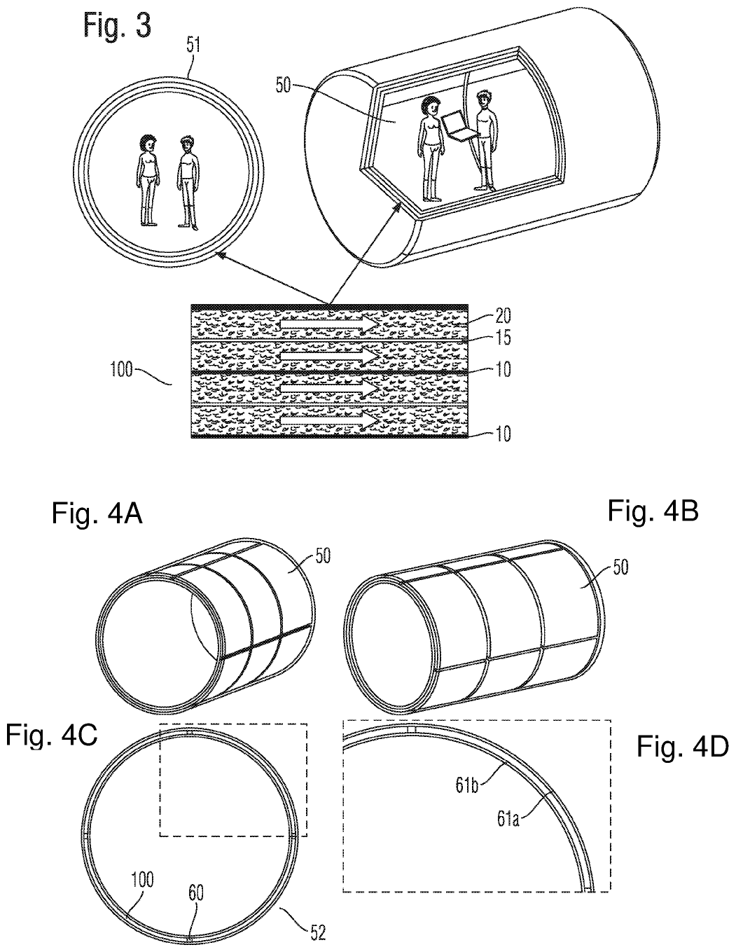

FIG. 3, in the bottom half of the picture, shows a bipolar sandwich structure of an electrochemical flow reactor (100) comprising porous electrodes (11, 12) (composed of a flexurally flexible metal foam in this embodiment), bipolar plates (10) and membranes (15), said bipolar sandwich structure being formed from electrochemical cells according to the application. The arrowheads point to the installation of this battery into the outer shell (51) of a space station module (50), said outer shell forming here at the same time, inter alia, a cylindrical support structure and shaping structure.

FIGS. 4A and 4B, top left and right, shows detail views of a cylindrical shaping structure (52). For example, this can be the shaping structure of a space station module (50). FIG. 4C, bottom left, shows the structural integration of the electrochemical flow reactor (100) into the shaping structure (52). In addition, strut elements (60) for mechanical stabilization can be seen here. In the detail view FIG. 4D, in the bottom right, it can be seen that the electrochemical flow reactor (100) is disposed in a form-fitting manner between an inner shell (61b) and outer shell (61a).

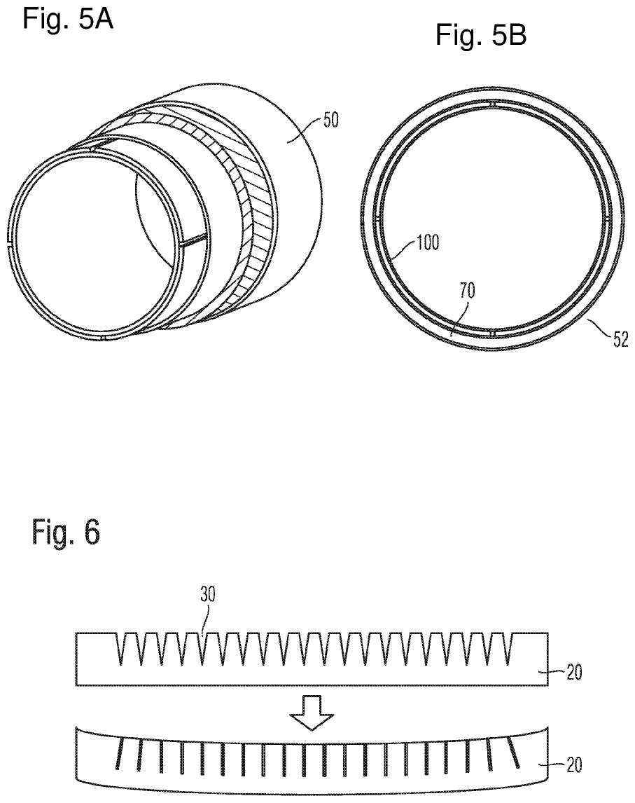

FIGS. 5A-5B show a further embodiment of a cylindrical shaping structure (52), which can be the shaping structure of a space station module (50). Here, in addition to the electrochemical flow reactor (100), an energy storage tank (70) is integrated into the shell of the spaceflight object.

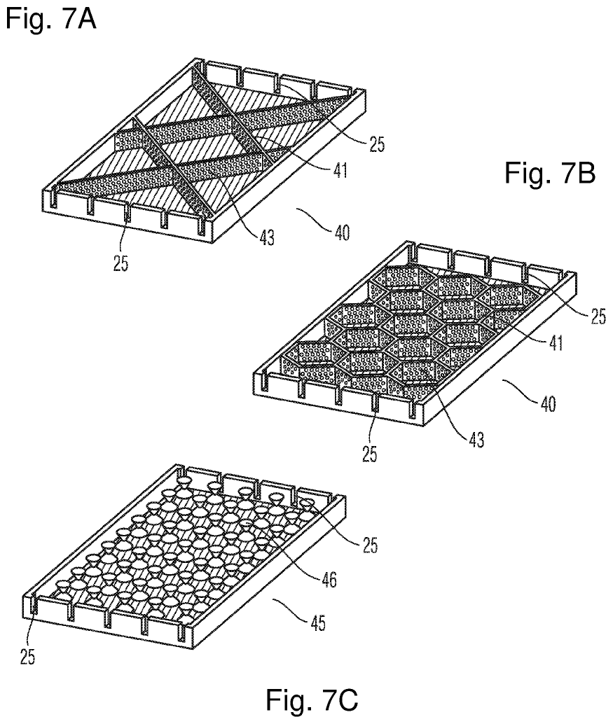

FIG. 6 shows an electrode (20) having a flexurally flexible structure before and after installation into a structural element of a mobile or stationary object. Here, the flexural flexibility (before installation) is realized by V-shaped material recesses (30). After installation (bottom), the material recesses are only slit-shaped; the electrode (20) has the shape of a cylindrical segment, or has been adapted to the structure of the mobile or stationary object, which is cylindrical here, during installation. FIGS. 7A-C show electrochemical flow cells, through which flow is possible, having additional stabilization structures. The embodiments in FIGS. 7A and 7B show flow cells having stabilization structures in the manner of a honeycomb (40), having diamond-shaped stabilization structures (41) in FIG. 7A and having honeycombed stabilization structures (42) in FIG. 7B; the embodiment in FIG. 7C shows a flow cell having column-type stabilization structures (45) in which the column-type stabilization structures (46) allow force absorption in the direction of the compressive forces acting on the cell. The cells each have a plurality of inflow openings and outflow openings (both with reference sign 25). In addition, the stabilization structures in the manner of a honeycomb have a multiplicity of perforations (43) in the honeycomb elements in order to allow the fluid to flow through.

1. An electrochemical cell, comprising:
a cell frame and an electrode, the cell frame perimetrically encloses a cell interior, and the cell frame comprises at least one supply channel for supplying a fluid into the cell interior and at least one discharge channel for discharging the fluid from the cell interior;
the cell frame and the electrode are substantially connected with a form-fit to one another, and are substantially connected with a form-fit to one another in a region of an active cell surface of the electrochemical cell.

2. The cell as claimed in claim 1, wherein
the cell is disposed in at least one of a support or shaping structure of either a stationary element of space travel or a mobile element.

3. The cell as claimed in claim 2, wherein
the cell is disposed in an outer shell of the stationary or mobile object.

4. The cell as claimed in claim 1, wherein
the electrode in the cell interior has at least partially a porosity for flow of the fluid which comprises an electrolyte therethrough from the at least one supply channel to the at least one discharge channel.

5. The cell as claimed in claim 4, wherein
the electrode is at least partially formed of an open-porous metal foam structure.

6. The cell as claimed in claim 4, wherein the electrode is formed from a porous, dimensionally stable carbon material.

7. The cell as claimed in claim 4, wherein
the electrode is formed of a porous material and is at least partially formed from fibrous structural elements.

8. The cell as claimed in claim 1, wherein
flow channels are formed in the electrode.

9. The cell as claimed in claim 1, wherein
the cell is at least one of flexurally flexible or positionally flexible in at least one of an installed or uninstalled state.

10. The cell as claimed in claim 9, wherein
at least the electrode is formed from at least one of a flexurally flexible or positionally flexible material.

11. The cell as claimed in claim 10, wherein the electrode has at least one of a flexurally flexible or positionally flexible geometry, provided by one or more material recesses in at least one surface enclosed by the cell frame.

12. The cell as claimed in claim 1, further comprising
mechanical stabilization structures are disposed in the cell interior in addition to the electrode, the mechanical stabilization structures comprise a honeycomb in which individual honeycomb elements are perforated in order to allow the fluid to flow through or column-type stabilization structures disposed between a semipermeable membrane and a bipolar plate substantially in a direction of active compressive forces.

13. A stack comprising a cell composite of two or more of the electrochemical cells as claimed in claim 1.

14. A structural assembly comprising a structural element of a stationary element of space travel or of a mobile element, the structural element performs at least one of a support or shaping function for the stationary or mobile element, and
the electrochemical cell as claimed in claim 1 is connected with a form fit to the structural element.

15. The structural assembly as claimed in claim 14, wherein the mobile element is a vehicle.

16. The structural assembly as claimed in claim 14, wherein the stationary element is a space station.

17. A structural assembly for at least one of aviation, shipping or space travel, the structural assembly comprising a structural element and the stack of claim 14 connected with the form-fit to the structural element.

18. The cell in claim 1, further comprising a semipermeable membrane and a bipolar plate in the cell interior, and the cell frame, the electrode, the semipermeable membrane and the bipolar plate are substantially connected with a form-fit to one another.

19. The cell in claim 5, wherein the open-porous metal foam structure comprises a metal mesh.

20. The cell in claim 6, wherein the porous, dimensionally stable carbon material comprises a carbon-based rigid nonwoven or rigid felt, from at least one of graphite fibers, carbon nanotubes, or an electrically conductive polymer-based composite.
